(19) United States
(12) Patent Application Publication
(10) Pub. No.: US 2016/0345601 A1
(43) Pub. Date: Dec. 1, 2016

(54) APPARATUS AND METHOD FOR PREPARING A DECORATED CAKE

(71) Applicant: Esther TOMMER, Sriggim (IL)

(72) Inventor: Esther TOMMER, Sriggim (IL)

(21) Appl. No.: 15/110,978

(22) PCT Filed: Jan. 19, 2015
(86) PCT No.: PCT/IL15/50063

§ 371 Date: Jul. 12, 2016

Related U.S. Application Data
(60) Provisional application No. 61/929,543, filed on Jan. 21, 2014.

(51) Int. Cl. A23G 3/28; A23G 3/34; A21C 15/00

(52) U.S. Cl. CPC A23G 3/28; A21C 15/002; A23G 3/0097

(57) ABSTRACT

A kit for preparing a decorated cake, which comprises a hollow receptacle that is shaped and dimensioned, essentially according to a desired size and shape of a cake to be prepared; an edible and ready to use rolled fondant applied to, and in engagement with, at least most of an inner face of said receptacle to define a fondant interior; and a cover for releasably covering said receptacle and for retaining said fondant in a fresh condition. A ready to serve decorated cake is exposable upon introduction of cake material into said fondant interior and inversion and subsequent removal of said receptacle.

### FIELD OF THE INVENTION

The present invention relates to the field of food preparation. More particularly, the invention relates to apparatus and method for preparing a decorated cake.

### BACKGROUND OF THE INVENTION

Edible rolled fondant, which is a type of sugar paste rolled out like a pie crust, is used by professional bakers to cover a cake. The rolled fondant generally includes gelatin or agar, as well as food-grade glycerine for maintaining the sugar pliable and producing a dough-like consistency, and may be colored and flavored.

After the fondant is sufficiently rolled and softened, it is lifted off the worktable and carefully adhered onto the cake, while ensuring that the entire top and sides of the cake are covered in a wrinkle-free manner. The fondant covering helps the cake underneath to stay moist, and constitutes a smooth support surface to which other edible decorations such as fine royal icing and selectively shaped three-dimensional elements can be applied.

Due to the time consuming process for preparing and applying rolled fondant, the cost of a decorated cake is high.

It is an object of the present invention to provide an apparatus and method for reducing the costs for preparing a decorated cake.

Other objects and advantages of the invention will become apparent as the description proceeds.

### SUMMARY OF THE INVENTION

The present invention provides a kit for preparing a decorated cake, comprising a hollow receptacle that is shaped and dimensioned, essentially according to a desired size and shape of a cake to be prepared; an edible and ready to use rolled fondant applied to, and in engagement with, at least most of an inner face of said receptacle to define a fondant interior; and a cover for releasably covering said receptacle and for retaining said fondant in a fresh condition, wherein a ready to serve decorated cake is exposable upon introduction of cake material into said fondant interior and inversion and subsequent removal of said receptacle.

In one aspect, the kit comprises a plurality of the hollow receptacles each of which is of a different size and nested one within the other, wherein a corresponding ready to use rolled fondant is applied to, and in engagement with, at least most of an inner face of each of said receptacles, and wherein the cover releasably covers said plurality of receptacles.

The present invention is also directed to a method for preparing a chilled decorated cake, comprising the steps of applying an edible and ready to use rolled fondant to an inner face of a hollow receptacle to define a fondant interior; introducing cake material into said fondant interior; sufficiently chilling said receptacle together with said fondant and said introduced cake material to prevent adhesion of said fondant to said receptacle; inverting said receptacle until a fondant engaged cake is lowered onto a tray; and lifting said receptacle so as to be separated from said tray and to expose said fondant engaged cake.

### BRIEF DESCRIPTION OF THE DRAWINGS

In the drawings:

FIGS. 1-8 are a method for preparing a decorated cake, according to an embodiment of the invention;

FIGS. 9-13 are a method for preparing a decorated cake, according to another embodiment of the invention;

FIG. 14 is an exploded view of a kit for preparing a decorated cake, according to another embodiment of the invention;

FIG. 15 is a front view of a cake prepared with the kit of FIG. 14; and

FIG. 16 is a perspective view from the top and side of a hollow receptacle formed with one or more three-dimensionally shaped ornamental cavities.

### DETAILED DESCRIPTION OF PREFERRED EMBODIMENTS

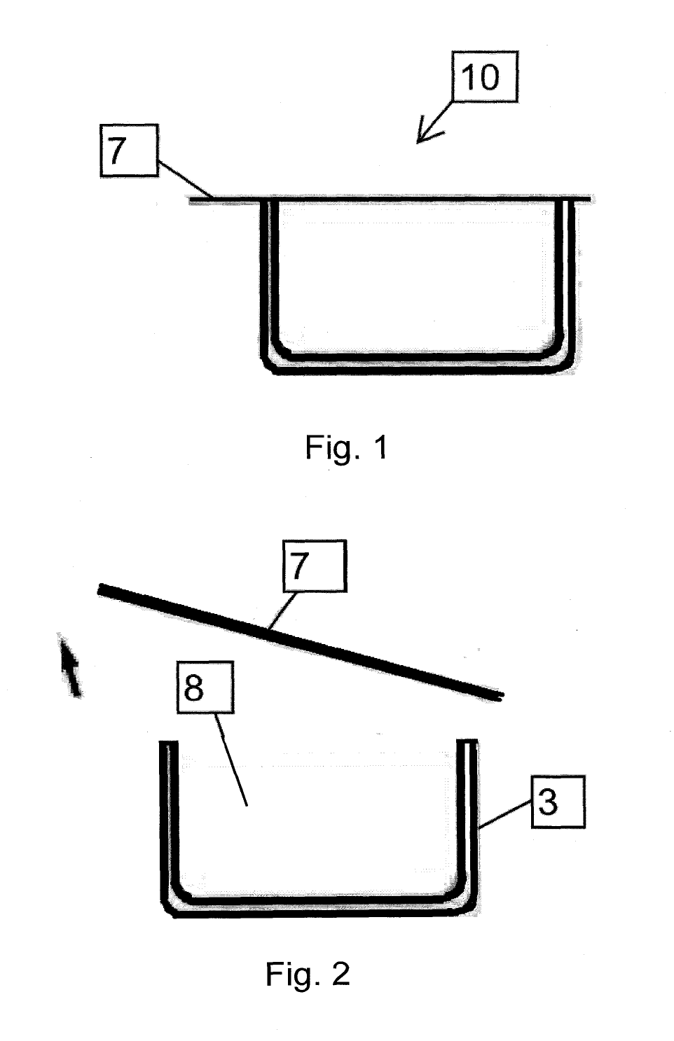

FIGS. 1-8 illustrate a method for quickly applying rolled fondant to a cake, according to one embodiment of the present invention.

By using the term “fondant” it is meant to include any edible crust, made of sweet dough and used to coat surfaces of a cake, so as to decorate the cake and add flavor to its texture. Such an edible crust may include marzipan, as well as gum paste or sugar paste.

FIG. 1 illustrates a kit 10 for preparing a decorated cake, according to one embodiment of the invention. Kit 10 comprises a hollow receptacle 3, e.g. cardboard mold, that is shaped and dimensioned according to the desired size of a cake to be prepared, a ready to use rolled fondant 5 applied to, and engagement with, the inner face of receptacle 3, and a cover 7, e.g. planar, for covering receptacle 3 and retaining fondant 5 in a fresh and appetizing condition.

Fondant 5 is a three-dimensional shell made of sugar paste, or any other edible paste, well known to cover and decorate a cake. The shell may be smooth, configured with two or three dimensional patterns or by different shapes and sizes. Fondant 5 may also have edible inserts, and be imprinted or otherwise provided with selected edible indicia or other decorations.

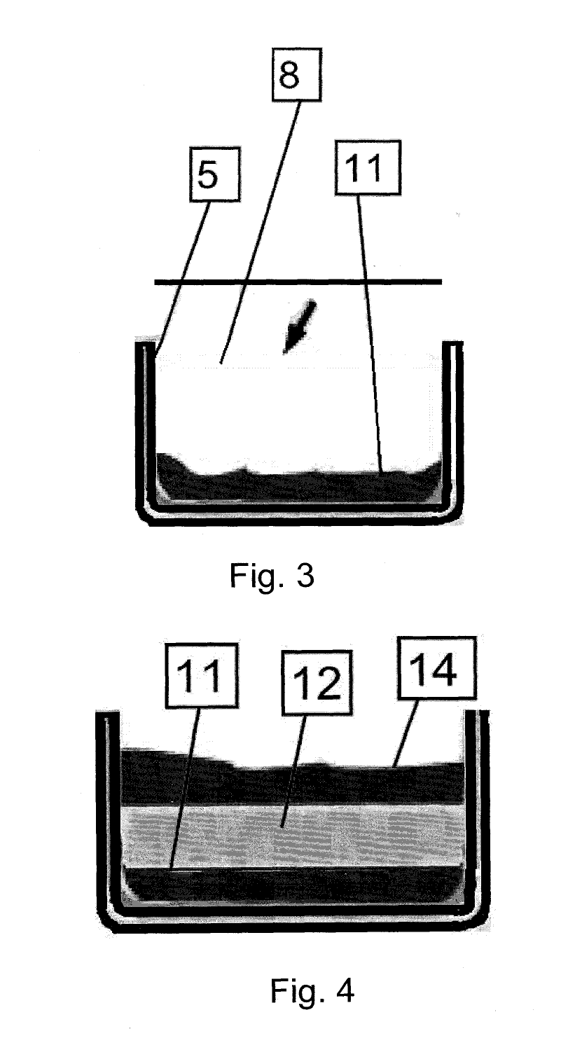

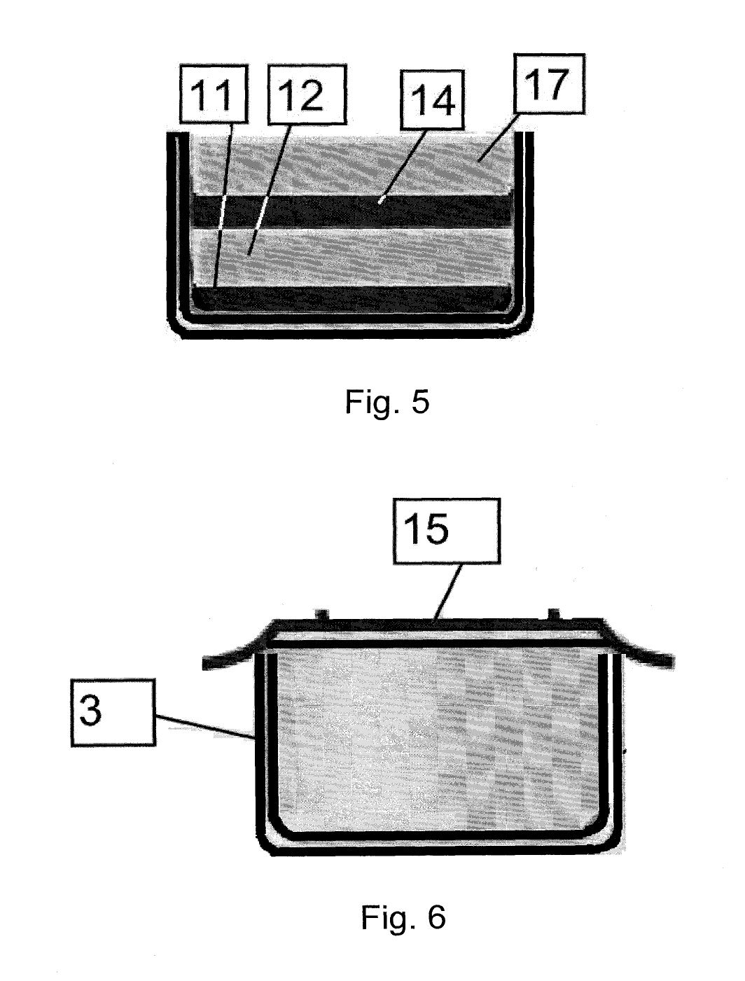

After cover 7 is removed, as shown in FIG. 2, to make the hollow interior 8 of receptacle 3 and fondant 5 accessible, a cream filling 11 is applied to fondant 5 at the bottom of interior 8, as shown in FIG. 3. A cake layer 12, e.g. a sponge cake or any other type of cake, is applied onto cream filling 11, and then a second cake layer 17 is applied to a second cream layer 14, as shown in FIGS. 4 and 5. Alternatively, any other previously prepared cake in an upside-down orientation may be lowered into interior 8 so as to be interfaced with fondant 5.

The introduced cake or cake and cream layers may be individually or commercially prepared. Alternatively, the kit may also be provided with a cake mix, a cream filling, or other sugar paste decorations.

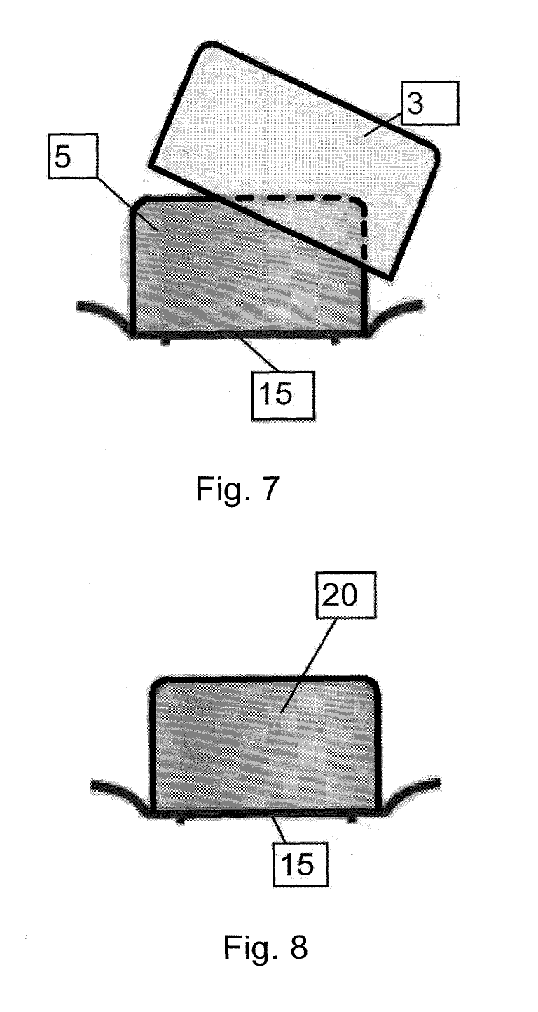

An upside-down tray 15, which may also provided with the kit, is then positioned on the top of receptacle 3, as shown in FIG. 6. The receptacle is then inverted such that the planar element of the tray 15 is positioned on an underlying surface and the fondant, together with the introduced cake material therewithin, is lowered onto the tray. After receptacle 3 is lifted and separated from tray 15 as shown in FIG. 7, a ready to serve decorated cake 20 overlying tray 15 becomes exposed. Fondant 5 tends to harden to a certain extent over the course of time, and therefore will essentially not adhere to receptacle 3 when the latter is lifted. Decorations may be applied to cake 20.

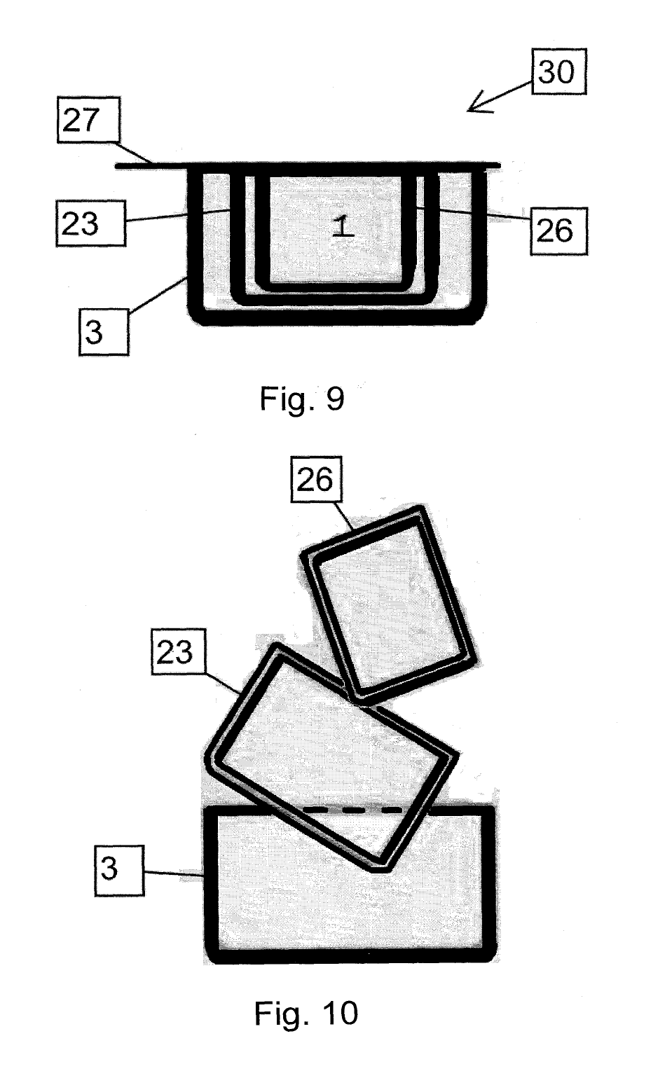

FIG. 9 illustrates a kit 30 according to another embodiment of the invention. Kit 30 comprises three hollow receptacles 3, 23 and 26 of different sizes nested one within the other. Each of the receptacles is arranged such that its bottom is downwardly positioned and its interior is accessible from above. Applied to, and engagement with, the inner face of each of the receptacles 3, 23 and 26 is a corresponding ready to use rolled fondant. The interior of receptacles 3, 23 and 26 is covered by cover 27.

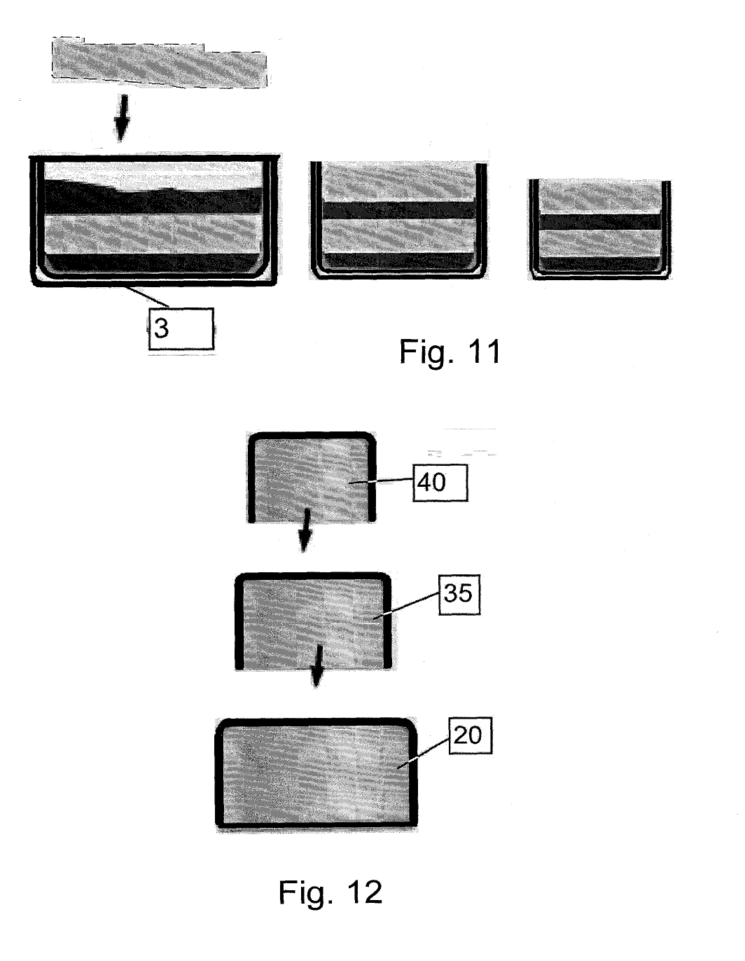

After receptacles 23 and 26 are removed from receptacle 3 and separated, as shown in FIG. 10, cake and cream material is added to the interior of each of the receptacles, as illustrated in FIG. 11.

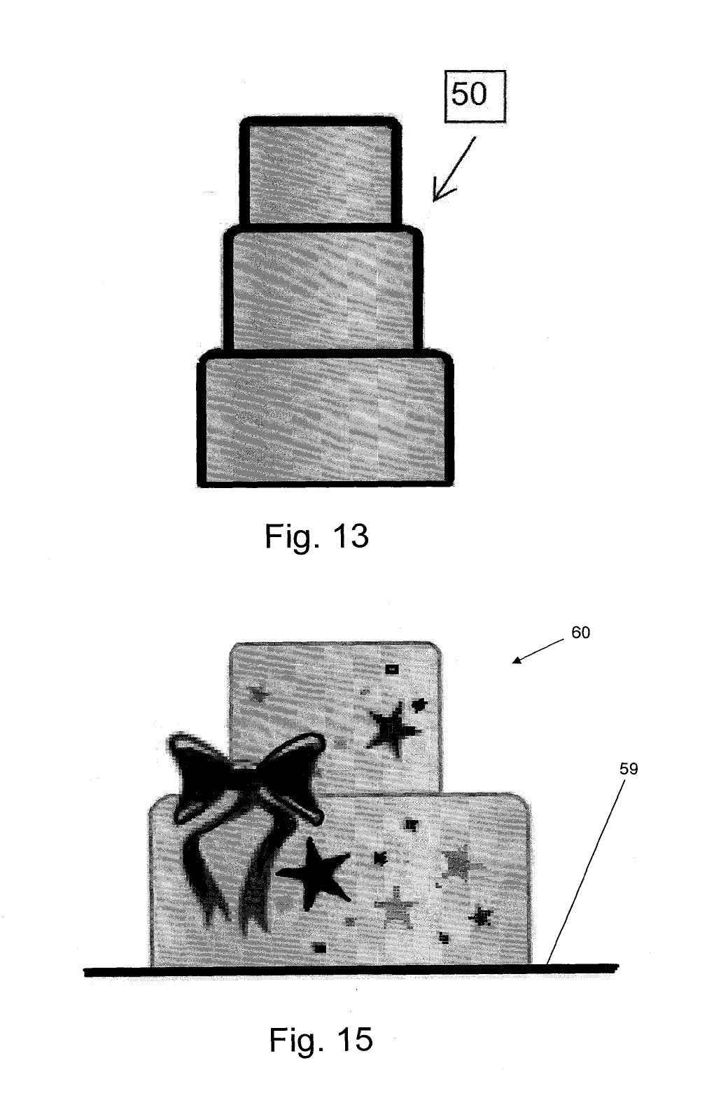

With reference to FIG. 12, receptacle 3 is then inverted, to discharge therefrom first level cake 20. Afterwards, receptacle 23 is inverted, to discharge therefrom second level cake 35 onto the top of first level cake 20. Receptacle 26 is then inverted, to discharge therefrom third level cake 40 onto the top of second level cake 35. A ready to serve decorated cake 50 shown in FIG. 13, suitable as a wedding cake, is thereby produced.

As may be appreciated from the above description, the kit of the present invention enables a fondant covered cake to be quickly and easily produced, together with a unique personal design. The method may be implemented for commercial, mass produced applications.

For additional cost savings, the receptacle may be reused, such as when made of plastic or is metallic. A more efficient cake preparing method may be realized when both a baking station and a receptacle inverting station are equipped with the same sized receptacle, to ensure that the baked cake will be introducible into the fondant interior prior to being inverted. Thus the discharging of the baked cake from the baking station may be synchronized with the transfer of a fondant applied receptacle to the receptacle inverting station.

In another embodiment of the invention, the fondant is ensured of being retained in applied relation to the outer receptacle by means of an inner securing receptacle. By retaining the fondant in applied relation to the outer receptacle, the design of the fondant is advantageously able to be displayed to the consumer at a store, thereby increasing the appeal of a kit.

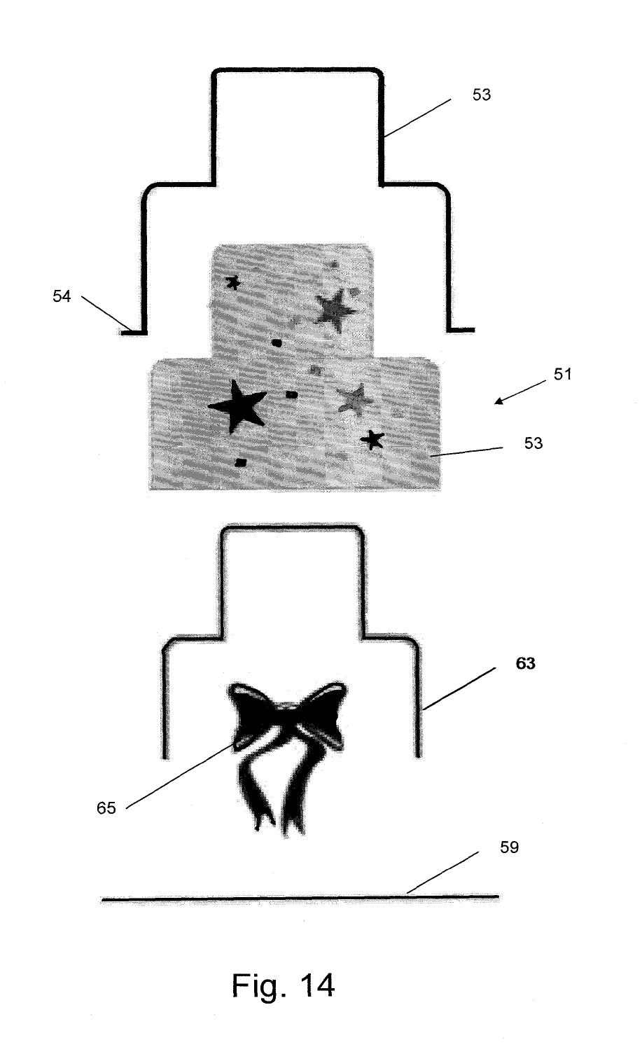

FIG. 14 illustrates a kit 55 for preparing a two-layered cake 60 shown in FIG. 15. Ready to use hollow fondant 51 is two-tiered such that the upper tier is of a smaller width than that of the lower tier. Outer receptacle 53 is also two-tiered, and fondant 51 is inserted within, and applied to the inner surfaces of, outer receptacle 53, so as to have a complementary shape of the latter. Outer receptacle 53 is provided with a lip 54 which is engageable with cover 59. Two-tiered securing receptacle 63 is insertable within the interior of fondant 51, and serves to urge fondant 51 towards outer receptacle 53 when cover 59 is engaged with lip 54 and contacts the wider portion of securing receptacle 63. Kit 55 also comprises decoration 65 that is received within the interior of securing receptacle 63.

The cake material may be baked within securing receptacle 63. After being baked, the cake material is removable from receptacle 63 and temporarily positionable on top of cover 59, also serving as the tray, after which it is introduced into the fondant interior. Outer receptacle 53 is then inverted until fondant engaged cake 60 is lowered onto cover 59. Securing receptacle 63 may be reused.

A kit may be envisioned to prepare a cake of any other desired number of tiers in similar fashion.

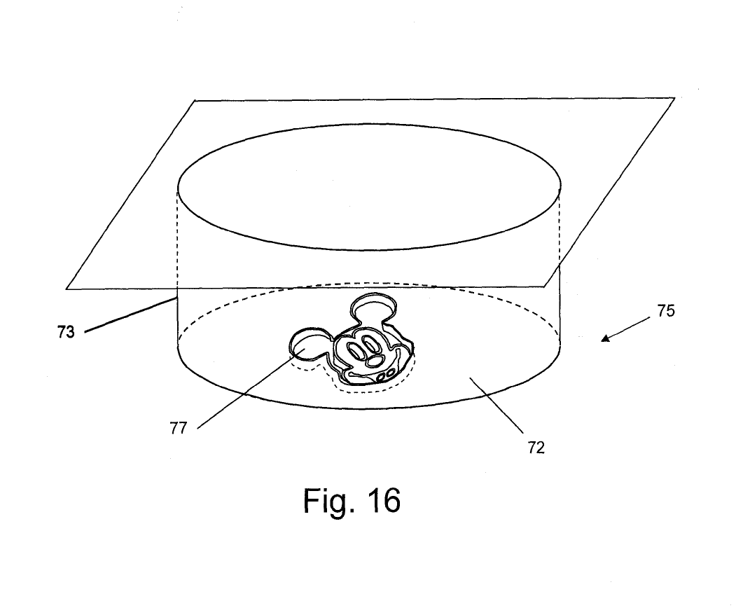

According to another embodiment as illustrated in FIG. 16, the closed bottom surface 72 of hollow receptacle 75 is formed with one or more three-dimensionally shaped cavities 77 recessed from surface 72, such as in the form of flowers or the illustrated exemplary Mickey Mouse design.

In use, ready rolled fondant is adapted to be applied to the inner face of bottom 72 and side 73 surfaces of receptacle 75, whether manually or by a mechanized process. After pressure is applied to the fondant, such as by a securing receptacle, the fondant is urged into cavity 77 and assumes the three-dimensional shape. Upon filling the interior of receptacle 75 with previously prepared cake material and inverting the receptacle, the latter may be removed to expose the fondant engaged cake, which is produced with an ornamental protrusion protruding from the fondant and complementary to the shape of cavity 77. This protrusion may be selectively colored as well known by those skilled in the art, such as by food coloring.

Alternatively, selectively colored fondant is applied (e.g., by injecting), whether manually or by a mechanized process, into a suitable region of cavity 77 to produce the three-dimensional ornamental projection. The main fondant is then applied to bottom 72 and side 73 surfaces of receptacle 75, as well as to the applied colored fondant, after which cake material is introduced into the interior of receptacle 75.

The hollow receptacle may also be pre-partitioned into separate members, which can be disconnected from each other by horizontal displacement, in order not to twist three-dimensionally shaped ornamental protrusions or indentations. These separate members may include handles, to allow proper grasping when separating between members.

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

1. A kit for preparing a decorated cake, comprising:
a) a hollow receptacle that is shaped and dimensioned, essentially according to a desired size and shape of a cake to be prepared;
b) an edible and ready to use rolled fondant applied to, and in engagement with, at least most of an inner face of said receptacle to define a fondant interior; and
c) a cover for releasably covering said receptacle and for retaining said fondant in a fresh condition,
wherein a ready to serve decorated cake is exposable upon introduction of cake material into said fondant interior and inversion and subsequent removal of said receptacle.

2. The kit according to claim 1, comprising a plurality of the hollow receptacles each of which is of a different size and nested one within the other, wherein a corresponding ready to use rolled fondant is applied to, and in engagement with, at least most of an inner face of each of said receptacles, and wherein the cover releasably covers said plurality of receptacles.

3. The kit according to claim 1, wherein the receptacle and fondant are multi-tiered.

4. The kit according to claim 1, further comprising an inner securing receptacle for urging the fondant towards the receptacle to which the fondant is applied, said securing receptacle being insertable within the interior of the fondant.

5. The kit according to claim 4, wherein the securing receptacle is oven durable, the cake material being bakable within the securing receptacle.

6. The kit according to claim 1, further comprising a tray positionable on a top of the receptacle, to receive the introduced cake material on a planar element of said tray following inversion of the receptacle.

7. The kit according to claim 1, further comprising a packet containing a cake mix for preparing the cake material.

8. The kit according to claim 1, further comprising a packet containing a cream filling which is applicable to the introduced cake material or to the fondant.

9. The kit according to claim 1, further comprising a packet containing one or more sugar paste decorations.

10. The kit according to claim 1, wherein the fondant is provided with edible inserts or imprinted with edible indicia.

11. The kit according to claim 10, wherein the edible inserts protrude from base fondant material and are receivable in complementary recesses of the receptacle.

12. The kit according to claim 1, wherein a closed bottom surface of the hollow receptacle is formed with one or more variably shaped cavities recessed from said bottom surface, for defining a correspondingly shaped decoration protrudable from the fondant.

13. The kit according to claim 1, wherein the receptacle is reusable.

14. The kit according to claim 4, wherein the securing receptacle is reusable.

15. A method for preparing a chilled decorated cake, comprising the steps of:
a) applying an edible and ready to use rolled fondant to an inner face of a hollow receptacle to define a fondant interior;
b) introducing cake material into said fondant interior;
c) sufficiently chilling said receptacle together with said fondant and said introduced cake material to prevent adhesion of said fondant to said receptacle;
d) inverting said receptacle until a fondant engaged cake is lowered onto a tray; and
e) lifting said receptacle so as to be separated from said tray and to expose said fondant engaged cake.

16. The method according to claim 15, further comprising the step of releasably covering the receptacle to retain the fondant in a fresh condition.

17. The method according to claim 15, further comprising the step of removing, from the fondant interior, a securing receptacle for urging the fondant towards the receptacle to which the fondant is applied, prior to the step of introducing cake material into said fondant interior.

18. The method according to claim 15, wherein a closed bottom surface of the hollow receptacle is formed with one or more variably shaped cavities recessed from said bottom surface, the method further comprising the step of applying pressure to a portion of the fondant which overlies the one or more cavities, to urge the overlying fondant portion into a corresponding cavity and to assume a three-dimensional shape for defining a correspondingly shaped decoration protrudable from the fondant.

19. The method according to claim 15, wherein a closed bottom surface of the hollow receptacle is formed with one or more variably shaped cavities recessed from said bottom surface, the method further comprising the step of applying selectively colored fondant into a desired region of the one or more cavities to produce a three-dimensional ornamental projection protrudable from the fondant.

20. The method according to claim 15, further comprising the steps of:
a) nesting a plurality of the hollow receptacles each of which is of a different size one within the other, wherein a corresponding ready to use rolled fondant is applied to, and in engagement with, at least most of an inner face of each of said receptacles;
b) separating each of the receptacles one from the other;
c) introducing the cake material into the fondant interior of each of the receptacles;
d) inverting a largest sized receptacle of said plurality of receptacles to discharge a first level cake onto the tray; and
e) inverting another receptacle of said plurality of receptacles which is smaller than said largest sized receptacle to discharge therefrom a second level cake onto said first level cake.
